(19) United States
(12) Patent Application Publication
(10) Pub. No.: US 2007/0083392 A1
(43) Pub. Date: Apr. 12, 2007

(54) Automatic Patient Parameter Acquisition System

(75) Inventor: John R. Zaleski, West Brandywine, PA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS MEDICAL SOLUTIONS HEALTH SERVICES CORPORATION, MALVERN, PA (US)

(21) Appl. No.: 11/467,728

(22) Filed: Aug. 28, 2006

Related U.S. Application Data
(60) Provisional application No. 60/724,534, filed on Oct. 7, 2005.

(51) Int. Cl. G06Q 10/00; G06Q 50/00

(52) U.S. Cl. 705/2

(57) ABSTRACT

A patient parameter acquisition interface system automatically acquires a patient parameter such as height or weight without human transcription error together with patient vital signs and provides the information to a clinical information system and other workflow applications that automatically use patient height (or other parameters) for calculations such as drug dosage. An automatic patient parameter acquisition system supports prescription of medication and includes an interface for automatically acquiring data representative of patient height from a patient height measurement device and an associated patient identifier. A data processor automatically processes the height representative data for storage in a patient record associated with the patient identifier. A storage processor stores the processed height representative data in the patient record associated with the patient identifier for automatic access by an executable application supporting medication prescription using the patient height.

This is a non-provisional application of provisional application Ser. No. 60/724,534 by J. Zaleski filed Oct.7, 2005.

### FIELD OF THE INVENTION

This invention concerns an automatic patient parameter acquisition system supporting prescription of medication in response to automatically acquired patient height and weight representative data.

### BACKGROUND OF THE INVENTION

During patient treatment, an observation (such as a height measurement) of a patient is typically manually recorded into a paper medical record. This manual operation is vulnerable to transcription error and usually involves a significant delay between observation data collection and communication of the information to other clinicians. The collected observation information is also available to a limited number of clinicians since availability is restricted to clinicians able to access the information from a paper chart that is usually located at a nurse station closest to a patient bed.

A more advanced observation data management system involves manually recording the observation information electronically via nurse data entry into an electronic medical record using a computer system, for example. This system is also vulnerable to transcription error and dependent on timely user entry of patient observation data into a patient medical record. Further, observation data entry and vital sign charting is delayed by the manual transcription process. Manual transcription accuracy is dependent on transcriber skill and conscientiousness and concentration in completing transcription. One source of commonly occurring transcription error is illegibility of a hand written observation produced by manual recording. An additional source of transcription error results from incorrect or incomplete recording of an observation resulting from inexperience, inattentiveness, or interruption. In addition, use of a paper chart to record an observation limits access to the information exclusively to clinicians able to read a chart at its current location. Often other clinicians, such as pharmacists, who have need for the information, need to either call or go to a nurse station to find the information. A system according to invention principles addresses these deficiencies and related problems.

### SUMMARY OF THE INVENTION

A patient parameter acquisition interface system automatically acquires a patient parameter such as height or weight without human transcription error and provides the information to a clinical information system and other workflow applications that automatically use the parameter for calculations such as drug dosage. An automatic patient parameter acquisition system supports prescription of medication and includes an interface for automatically acquiring data representative of patient height from a patient height measurement device and an associated patient identifier. A data processor automatically processes the height representative data for storage in a patient record associated with the patient identifier. A storage processor stores the processed height representative data in the patient record associated with the patient identifier for automatic access by an executable application supporting medication prescription using the patient height.

### BRIEF DESCRIPTION OF THE DRAWING

FIG. 1 shows an automatic patient parameter acquisition system supporting medication prescription, according to invention principles.

FIG. 2 shows a patient height scale for automatically acquiring patient height data, according to invention principles.

FIG. 3 shows a user interface display image employed by an automatic patient parameter acquisition system supporting medication prescription, according to invention principles.

### DETAILED DESCRIPTION OF THE INVENTION

A system according to invention principles employs an interface that connects multi-functional (weight, height) scales with a hospital information system (HIS), such as a Clinical Information System. The system acquires information in response to minimized and streamlined user command to initiate identification of a patient and to communicate observations to an HIS for storage and display. The system eliminates manual transcription of physical information, specifically patient height or weight, for example, by means of a mechanical to electronic interface connected to an information system. The system employs a universal adaptor process that advantageously facilitates adapting height or weight scale operation of multiple different scale devices from different manufacturers. The system also acquires height or weight information using a mechanical-electronic interface that records the height and weight, for example, concurrently with a patient parameter measurement event. The system interface enables connectivity to Weight/Height scales from a wide number of manufacturers using standard Internet protocols (and other communication protocols) and hardware connectivity components (e.g., supportingRS232 protocol). The adaptive system interface reduces costs by eliminating expensive interface hardware and software components and facilitating support of different scales by use of a common interface that reduces the need for interface experts. The system interface eliminates transcription errors and enables quick collection of data for display by applications, such as Microsoft Net Access, that distribute the information and collate it with other relevant patient information. The system also reduces patient safety errors by automatically positively associating a weight or height observation with a correct patient.

An executable application as used herein comprises code or machine readable instruction for implementing predetermined functions including those of an operating system, healthcare information system or other information processing system, for example, in response user command or input. An executable procedure is a segment of code (machine readable instruction), sub-routine, or other distinct section of code or portion of an executable application for performing one or more particular processes and may include performing operations on received input parameters (or in response to received input parameters) and provide resulting output parameters. A processor as used herein is a device and/or set of machine-readable instructions for performing tasks. A processor comprises any one or combination of, hardware, firmware, and/or software. A processor acts upon information by manipulating, analyzing, modifying, converting or transmitting information for use by an executable procedure or an information device, and/or by routing the information to an output device. A processor may use or comprise the capabilities of a controller or microprocessor, for example. A display processor or generator is a known element comprising electronic circuitry or software or a combination of both for generating display images or portions thereof. A user interface comprises one or more display images enabling user interaction with a processor or other device.

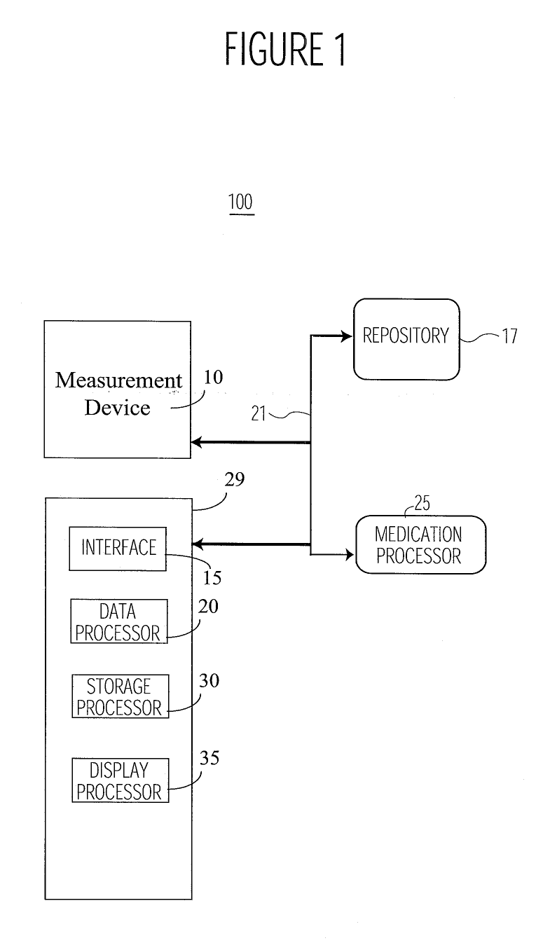

FIG. 1 shows an automatic patient parameter acquisition system 100 supporting medication prescription. System 100 employs an interfacing application 29 coupled to a patient weight and/or height measurement device 10, repository 17 and medication processor 25 via network 21. Application 29 includes interface 15 for automatically acquiring data representative of patient height (and weight) from one or more patient height (or weight) measurement devices 10 and an associated patient identifier and acquires clinical data from a record associated with the patient identifier. Interface 15 advantageously uses standard communication protocols (e.g., Internet compatible or RS 232 compatible protocols) in communicating with measurement device 10. Data processor 20 automatically processes the height (and weight) representative data using analog to digital conversion for storage in a patient record associated with the patient identifier. Data processor 20 also automatically processes the weight and height representative data to determine body surface area of a patient based on predetermined information associating weight, height, age, gender and body surface area derived from averaging and categorizing body surface area values of a human population. Other factors may also be used in determining body surface area such as race and nationality in other embodiments.

Storage processor 30 stores the processed height (and weight) representative data in the patient record (in repository 17) associated with the patient identifier. The stored data is automatically accessed by an executable application supporting medication prescription (medication processor 25) using the patient height and weight. Medication processor 25 uses the acquired clinical data and the patient height (and weight) data in performing a medication safety check for the patient. The medication safety check comprises a medication dosage check, a medication interaction check and a check for duplicate medications being prescribed for the patient. The calculated body surface area is also used in medication prescription, e.g., of a topical medication by unit 25, for example. Display processor 35 initiates generation of data representing a display image including the patient height (and/or weight) data. The display image also includes other patient parameters such as vital signs (heart rate, blood pressure, blood oxygen saturation, ECG etc.). Display processor 35 initiates generation of data representing at least one display image enabling a user to enter configuration information determining units of measurement to be used for a patient parameter such as, (a) patient height, (b) patient weight and (c) body surface area calculated from weight and height.

In one embodiment, interface 15 also automatically acquires data representative of both patient weight and height from one or more patient weight and height measurement devices 10 and data processor 20 also automatically processes the weight representative data for storage in the patient record associated with the patient identifier.

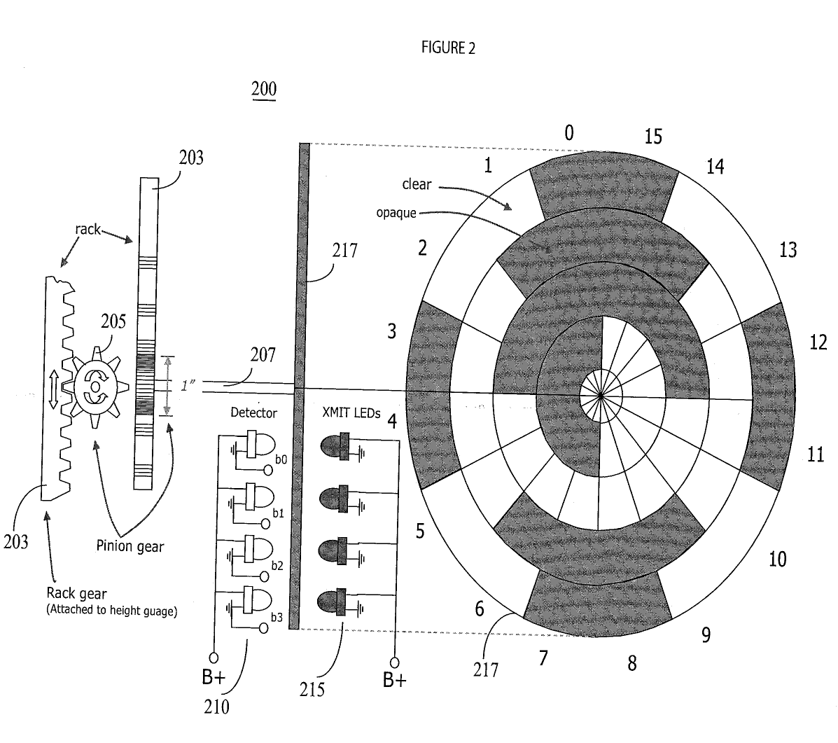

FIG. 2 shows a patient height scale mechanical to electronic interface 200 in a measurement device 10 for automatically acquiring patient height data. The height scale mechanical to electronic interface 200 is located between a vertical measurement scale inscribed with height values placed adjacent to a patient and an electronic height gauge receiving electronic data representing automatically acquired patient height representative data. Interface 200 acquires height data using a an electronic or mechanical counter that translates data derived in response to placing a height bar on top of a patient head when the patient is standing fully erect. Data provided by interface 200 is converted by device 10 to electronic patient height representative information for storage in an electronic patient record. The system includes an analog to digital interface.

The vertical measurement scale inscribed with height values (part of interface 200) is nominally adjustable from 34 to 72 inches (this is variable). A linear rack gear 203 is attached to the moving patient height bar placed on top of the patient and moves with the height bar as it traverses the vertical measurement scale. Linear rack 203 meshes with pinion gear 205 of radius R such that one inch of travel of the height gauge translates into one complete rotation of the pinion gear. So, the circumference of pinion gear 205=C=2* pi*R, or R=1/(2*pi) inches. Shaft 207 is axially attached to pinion gear 205 and to rotating disk 217. Rotating disk 217 contains holes as illustrated in circumference bands equally divided into sectors of 360 degrees/8, or 2 pi radians/8, or pi/4 radian sectors each (e.g., a gray code pattern). This is done so that for each quarter inch of extension of rack 203 there is one transit across a set of holes within the rotating disk, for example. Sections of transparent and opaque plastic disk 217 alternatively transmit and block light between transmitting and detecting devices 215 and 210 respectively. The resulting signal sequence is captured in interface 200 and used in determining whether the vertical height bar is gaining or reducing in height.

Disk 217 and associated holes pass between led transmitter 215 and corresponding photo-detector 210 such that as a hole passes upon rotation of disk 217, a light signal is detected at the photo-detector 210. The detected led signal is amplified and passed to an integrator plus counter circuit that adds the number of hole passages (starting from the lowest point, or zero). The Gray code output (b0 b1 b2 b3) is converted by an analog-to-digital converter to digital data for integration. The counts are translated into height in inches (or other units as selected) by an executable application in interface 200 within measurement unit 10 (FIG. 1). Patient height data is automatically communicated to interface 15 using a standard Internet compatible or RS232 interface and 9-pin adapter cable, for example.

Interface system 200 adaptively accommodates English or Metrics measurements and standard units of the vertical measurement scale are specified in both English and Metric units. An output of interface 200 provides English or Metric patient height data via an RS-232 port to interface 15. The units may be configured in response to user preference and interface 200 enables a user to toggle between English or Metric units as desired.

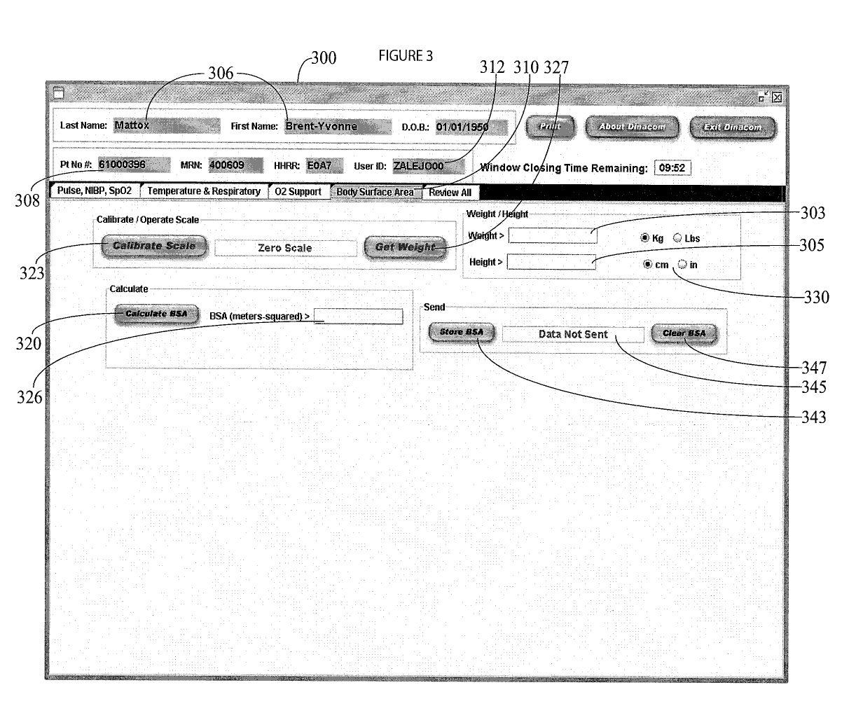

FIG. 3 shows a user interface display image 300 provided by display processor 35 of automatic patient parameter acquisition system 100 supporting medication prescription. FIG. 3 illustrates a user interface image employed in automatic body surface area determination of a patient used in medication prescription and is initiated by a user by selection of Body Surface Area tab 310. Height and weight data of a patient are automatically acquired by measurement device 10 and displayed in boxes 303 and 305 in response to a user identified by item 312 initiating selection of button 327 (Get weight). The patient is identified by items 306 and 308. A user further selects units of the weight or height data by selecting either the “Kg-cm” or “Lbs-in” buttons of items 330 to present and process the data in either Metric or English units of measurement. A user is able to calibrate measurement device 10 via selection of button 323. This ensures the patient height and weight measurement devices 10 read zero values for corresponding zero input conditions

Data processor 20 (FIG. 1) computes body surface area of a patient based on height and weight data in response to user selection of button (calculate BSA) 320 data. The calculated BSA data is presented in item 326. In another embodiment the BSA data is automatically computed by data processor 20 once patient height and weight data is available. Data processor 20 determines BSA data of a patient in response to patient height and weight based on predetermined tables of information associating weight and height data with a BSA value (in meters squared). The predetermined data may be further refined in other embodiments based on patient characteristics including age, gender, race etc. The patient height, weight and BSA data is automatically provided to medication prescription processor 25 and used in accurately determining dosage or validating a selected dosage. The calculated BSA (or patient height, weight) data is communicated to a hospital information system for storage in (and subsequent retrieval from) a patient long-term clinical record in response to user selection of button 343 (or automatically in another embodiment). Message box 345 provides a user with an alert message indicating whether or not the patient data was successfully stored, communicated or calculated and button 347 enables a user to clear a current BSA value.

System 100 connects and integrates a mechanical-electronic interface height gauge and weight gauge with an electronic patient record and facilitates interfacing Weight/Height scales to automatically collect-accurate height information to support BSA computation and medication prescription. Nurses use system 100 to collect patient weight and height information accurately and effectively. Thereby, patient care is more efficient as the height data is available for access by clinical users (doctors, nurses, other care givers) substantially simultaneously with a collection event. System 100 aids pharmacists to calculate medication dosages using accurate height and weight information and also aids dietitians to calculate body mass index (BMI) that is vital in preparation of special diets for diabetic patients and patients with eating disorders. System 100 further aids nephrologists to proscribe protocols for renal dialysis.

The systems presented in FIGS. 1-3 are not exclusive. Other systems and processes may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. A system according to invention principles is applicable to automatically acquire patient data for use by any Clinical Information System and workflow application including supporting medication prescription as well as prescription and dosage validation. Further, any of the functions provided in the system of FIG. 1 may be implemented in hardware, software or a combination of both and may reside on one or more processing devices located at any location of a network linking the FIG. 1 elements or another linked network including another intra-net or the Internet.

What is claimed is:

1. An automatic patient parameter acquisition system supporting prescription of medication, comprising:
an interface for automatically acquiring data representative of patient height from a patient height measurement device and an associated patient identifier;
a data processor for automatically processing said height representative data for storage in a patient record associated with said patient identifier; and
a storage processor for storing said processed height representative data in said patient record associated with said patient identifier for automatic access by an executable application supporting medication prescription using said patient height.

2. A system according to claim 1, wherein
said interface for automatically acquiring data representative of patient weight from a patient height measurement device,
said data processor for automatically processes said weight representative data for storage in said patient record associated with said patient identifier; and
said storage processor stores said processed weight representative data in said patient record associated with said patient identifier for automatic access by said executable application supporting medication prescription using said patient weight.

3. A system according to claim 1, including
a display processor for initiating generation of data representing a display image including said patient height data.

4. A system according to claim 3, wherein
said display processor initiates generation of data representing at least one display image enabling a user to enter configuration information determining units of measurement to be used for data indicating at least one, (a) patient height, (b) patient weight and (c) body surface area calculated from weight and height.

5. A system according to claim 1, wherein
said data processor automatically processes said height representative data using analog to digital conversion.

6. A system according to claim 1, wherein
said interface automatically acquires clinical data from a record associated with said patient identifier and
said executable application supporting medication prescription uses said acquired clinical data and said patient height data in performing a medication safety check for said patient.

7. A system according to claim 6, wherein
said medication safety check comprises a medication dosage check.

8. A system according to claim 6, wherein
said medication safety check comprises at least one of, (a) a medication interaction check and (b) a check for duplicate medications being prescribed for said patient.

9. A system according to claim 1, wherein
said interface automatically acquires said data representative of patient height from said patient height measurement device using a standard communication protocol including at least one of, (a) an Internet compatible protocol and (b) an RS 232 compatible protocol.

10. An automatic patient parameter acquisition system supporting prescription of medication, comprising:
an interface for automatically acquiring data representative of patient weight from a patient height measurement device and an associated patient identifier;
a data processor for automatically processing said weight representative data for storage in a patient record associated with said patient identifier; and
a storage processor for storing said processed weight representative data in said patient record associated with said patient identifier for automatic access by an executable application supporting medication prescription using said patient weight.

11. A system according to claim 10, wherein
said interface automatically acquires clinical data from a record associated with said patient identifier and
said executable application supporting medication prescription uses said acquired clinical data and said patient weight data in performing a medication safety check for said patient.

12. A system according to claim 11, wherein
said medication safety check comprises a medication dosage check.

13. A system according to claim 11, wherein
said medication safety check comprises at least one of, (a) a medication interaction check and (b) a check for duplicate medications being prescribed for said patient.

14. An automatic patient parameter acquisition system supporting prescription of medication, comprising:
an interface for automatically acquiring data representative of patient weight and height from a patient weight and height measurement devices and an associated patient identifier;
a data processor for automatically processing said weight and height representative data for storage in a patient record associated with said patient identifier; and
a storage processor for storing said processed weight and height representative data in said patient record associated with said patient identifier for automatic access by an executable application supporting medication prescription using said patient weight and height.

15. A system according to claim 14, wherein
said data processor automatically processes said weight and height representative data to determine body surface area of a patient.

16. A system according to claim 15, wherein
said data processor determines said body surface area based on predetermined information associating weight, height and body surface area.

17. A system according to claim 16, wherein
said predetermined information associates weight, height, age, gender and body surface area and
said data processor determines said body surface area based on said predetermined information.
